(19) United States
(12) Patent Application Publication
(10) Pub. No.: US 2018/0165263 A1
(43) Pub. Date: Jun. 14, 2018

(54) AUTOMATICALLY OR SEMI-AUTOMATICALLY ADAPTING FEEDBACK RECEIVED ON A DOCUMENT

(71) Applicant: Microsoft Technology Licensing, LLC, Redmond, WA (US)

(72) Inventors: Christopher Lee Mullins, Sammamish, WA (US); Robert Earl Standefer, III, Duvall, WA (US)

(21) Appl. No.: 15/379,326

(22) Filed: Dec. 14, 2016

(51) Int. Cl. G06F 17/24; G06F 3/0482; G06F 17/30

(52) U.S. Cl. CPC G06F 17/241; G06F 17/30958; G06F 3/0482

(57) ABSTRACT

A facility for procuring feedback on a document on behalf of an author of the document is described. The facility receives first input originated by the author usable to identify prospective reviewers. The facility obtains feedback on the document from each of a first group of the identified prospective reviewers. The facility causes a representation of the obtained feedback to be presented to the author, and receives second input originated by the author indicating that additional feedback is needed. In response to receiving the second input, the facility obtains feedback on the document from each of a second group of identified prospective reviewers that is distinct from the first group.

### BACKGROUND

Electronic documents are prepared by one or more authors to contain content such as text, spreadsheets, slides, diagrams, charts, and images.

In some cases, authors use informal processes—such as manually generating email requests—to seek feedback on the documents they prepare, such as editorial feedback on the message; grammar feedback on the writing; style feedback on the visual appearance; audience suitability feedback; publication authorization; legal clearance; etc.

### SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility for procuring feedback on a document on behalf of an author of the document is described. The facility receives first input originated by the author usable to identify prospective reviewers. The facility obtains feedback on the document from each of a first group of the identified prospective reviewers. The facility causes a representation of the obtained feedback to be presented to the author, and receives second input originated by the author indicating that additional feedback is needed. In response to receiving the second input, the facility obtains feedback on the document from each of a second group of identified prospective reviewers that is distinct from the first group.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing a process performed by the facility in some embodiments to solicit feedback on a document and adjust it in a semi-automatic manner.

FIG. 3 is a display diagram showing a sample display presented by the facility in some embodiments to receive a request for feedback on a document from its author.

FIG. 4 is a display diagram showing a sample feedback solicitation message sent by the facility to prospective reviewers in some embodiments.

FIG. 5 is a display diagram showing a sample display presented by the facility in some embodiments to present to the author information about feedback received on the document.

FIG. 6 is a display diagram showing a sample display presented by the facility in some embodiments in which the user has dragged the slider control's slider handle to the right in order to request more feedback.

FIG. 7 is a display diagram showing a sample display presented by the facility in some embodiments that reflects the facility's collection of additional feedback in response to the author's request.

FIG. 8 is a flow diagram showing a process performed by the facility in some embodiments to solicit feedback on a document and adjust it in an automatic manner.

### DETAILED DESCRIPTION

The inventors have recognized that conventional informal approaches used by authors to seek feedback on an electronic document (hereafter simply a “document”) have significant disadvantages. A first disadvantage identified by the inventors is that the author must typically do the following things manually, on an ad hoc basis: identify prospective reviewers; prepare and send an email message or other communication to each of the prospective reviewers; and aggregate feedback received from some or all of the prospective reviewers. A second disadvantage identified by the inventors is that it often turns out to be true that the number of prospective reviewers who respond with feedback differs meaningfully from what turns out to be, in the final analysis, the ideal number of respondents; in this situation, conventionally the author must manually prepare and send solicitations to additional prospective reviewers (if not enough reviewers have responded), or manually identify responding reviewers whose feedback is to be discarded or disregarded (if too many reviewers have responded).

In response to this recognition, the inventors have conceived and reduced to practice a software and/or hardware facility (“the facility”) for automatically or semi-automatically adapting feedback received on a document.

In some embodiments, the facility permits an author to provide information about feedback desired on a document, including, for example: one or more types of feedback desired; for each type of feedback, the number of people from whom this type of feedback is desired, and any qualifications that a person providing this type of feedback should have, such as certain skills, expertise, or certifications, certain kinds of authority within an organization, certain connections to the author, etc. In some embodiments, the author can explicitly identify prospective reviewers for any of the categories, though in some embodiments, where the author does not explicitly identify prospective reviewers or identifies an inadequate number, the facility automatically identifies prospective reviewers. In some embodiments, the facility automatically generates and sends communications to the identified prospective reviewers soliciting their assistance to provide the desired type(s) of feedback. The facility collects the feedback as it is provided by reviewers.

In one example, the author of a “January Status Memo” document provides information indicating that she desires a single type of feedback on the document, notes on whether the document should be revised. She further specifies that, as a qualification, reviewers should be members of a particular management team, and that feedback is desired from five people. In response, the facility generates and sends feedback solicitations to eight people.

In some semi-automatic embodiments, the facility presents to the author a representation of the feedback collected from reviewers, such as by displaying the feedback itself, a summary of the feedback, account of the reviewers providing feedback, etc. With this representation of the feedback, the facility presents a control that the author can operate to adjust the amount of feedback. The author can move the control in a first direction, such as to the left or counter-clockwise, in order to reduce the amount of feedback; the author can move the control in a second direction, such as to the right or clockwise, in order to increase the amount of feedback. In some embodiments, by moving the control to different degrees, the author can reduce or increase the amount of feedback to different extents. When the author operates the control to reduce the amount of feedback, the facility filters the feedback received from reviewers, removing feedback inferred to be the least relevant or helpful, such as by removing feedback received from reviewers that least satisfy reviewer qualifications specified by the author; removing feedback received from reviewers furthest from the author in a relevant social or organizational graph; removing feedback judged on helpful based upon natural language processing and size or natural language understanding; etc. When the author operates the control to increase the amount of feedback, in various embodiments, the facility takes various approaches, such as sending solicitations to additional prospective reviewers; sending already-solicited prospective reviewers who have not responded a message with different content; sending already-solicited prospective reviewers who have not responded a message the different communication channel; etc.

To extend the example in accordance with the semi-automatic embodiments described above, the facility receives notes feedback from four of the eight people to whom solicitations were sent, and displays a list of this notes feedback. The facility also displays a slider control that the author can drag to the left to reduce the amount of feedback by filtering out feedback likely to be least relevant, or drag to the right to increase the amount of feedback. In this case, the author drags the slider control to the right to increase the amount of feedback. In response, the facility sends solicitations to 10 more people; receives feedback from five of them; and displays a list of feedback that includes the feedback received from the original four reviewers together with the feedback received from the additional five reviewers. At this point, the author can again manipulate the slider control to further adjust the amount of feedback.

In some embodiments that are more automatic, the facility itself compares the number of people from whom feedback was collected to the number of people from whom feedback was desired by the author, and automatically takes action to reduce or increase the amount of feedback, such as in the ways described above.

To extend the example in accordance with the more automatic embodiments described above, the facility receives notes feedback from four of the people to whom solicitations were sent. The facility determines that this feedback from four people falls below the number of people from which the author desires feedback, and sends solicitations to three additional people. When the facility receives feedback from all of these three additional people, and determines that the feedback it now has from seven people exceeds the number of people from which the author desires feedback, the facility filters the feedback by removing the feedback from the two people for the furthest from the author in the relevant organizational graph. The facility then presents the remaining feedback from five people.

In some embodiments, where a document has a single author, that author can use the facility to adapt feedback received for the document. In some embodiments, where a document has multiple authors, any or all of the authors can use the facility to adapt feedback received for the document. In various embodiments, the facility can be used by people having various roles other than author with respect to the document, including, for example, editors, approvers, publishers, referees, etc.

By performing in some or all of these ways, the facility makes it easy for an author to obtain and adjust various kinds of feedback on a document prepared by the author.

Also, by performing in some or all of the ways described above and storing, organizing, and accessing information relating to a document graph in an efficient way, the facility meaningfully reduces the hardware resources needed to obtain feedback and adjust its amount, including, for example: reducing the amount of storage space needed and reducing the number of processing cycles needed. This allows programs making use of the facility to execute on computer systems that have less storage and processing capacity, occupy less physical space, consume less energy, produce less heat, and are less expensive to acquire and operate. Also, such a computer system can respond to user requests with less latency, producing a better user experience and allowing users to do a particular amount of work in less time.

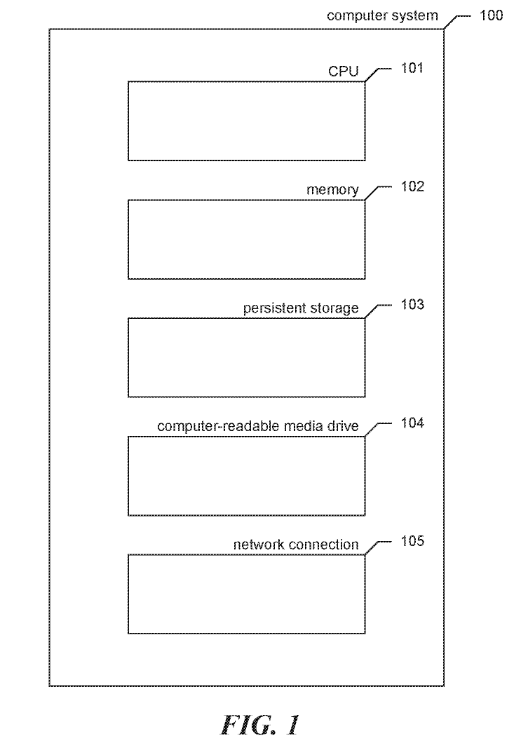

FIG. 1 is a block diagram showing some of the components typically incorporated in at least some of the computer systems and other devices on which the facility operates. In various embodiments, these computer systems and other devices 100 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

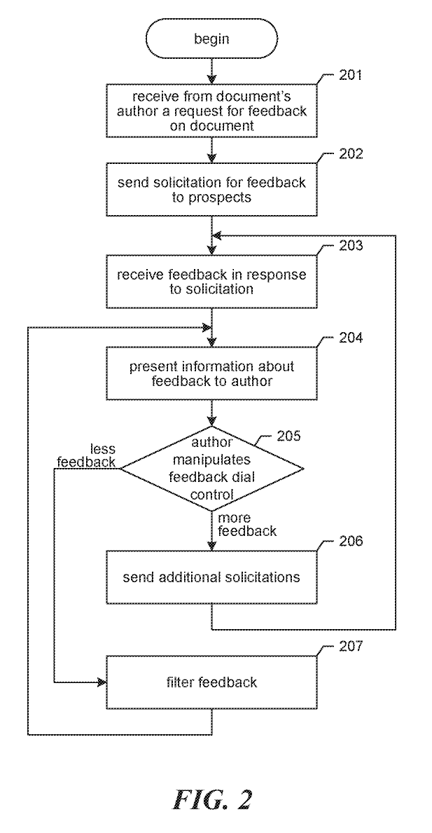

FIG. 2 is a flow diagram showing a process performed by the facility in some embodiments to solicit feedback on a document and adjust it in a semi-automatic manner. In act 201, the facility receives from the author of the document a request for feedback on the document.

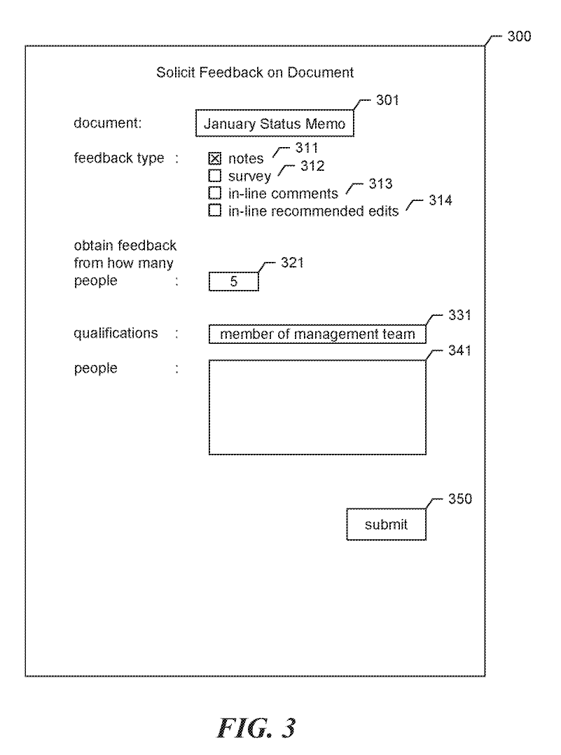

FIG. 3 is a display diagram showing a sample display presented by the facility in some embodiments to receive a request for feedback on a document from its author. Display 300 includes information 301 identifying the document of feedback types 311-314 that the author can select to request feedback of this type. For example, here, the author has selected the notes feedback type 311 by clicking on it or the checkbox to its left. The display also includes a field 321 into which the user can enter the number of people from whom feedback should be obtained. The display also includes a field 321 into which the user can enter qualifications to be satisfied by people providing feedback. The display also includes a field 341 into which the user can enter the names or other identifiers of people from whom feedback should be solicited. After providing some or all of this information, the user can activate a submit control 350 in order to submit the request for feedback.

Returning to FIG. 2, in act 202, the facility sends a solicitation for feedback to prospective reviewers.

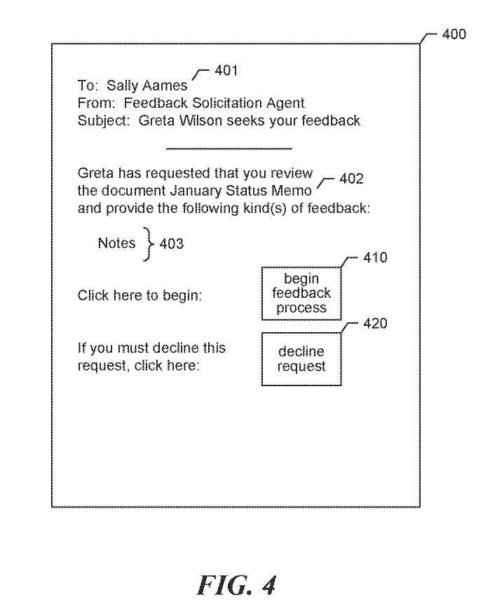

FIG. 4 is a display diagram showing a sample feedback solicitation message sent by the facility to prospective reviewers in some embodiments. The message 400 includes an email header 401; text including the document's name 402 requesting feedback from the prospective reviewer; and an indication 403 of the type or types of feedback requested. The prospective reviewer can activate a begin feedback process control 410 to initiate the process of providing feedback, or operate a decline request control 420 to indicate that they will not provide feedback. In various embodiments, for prospective reviewers who provide feedback, feedback is provided in various ways, such as, for example, typing free-form notes; responding to a survey; annotating the document with comments and/or edits; etc.

Returning to FIG. 2, in act 203, the facility receives feedback from one or more reviewers in response to the solicitation sent in act 202. In act 204, the facility presents to the author information about the feedback received in act 203.

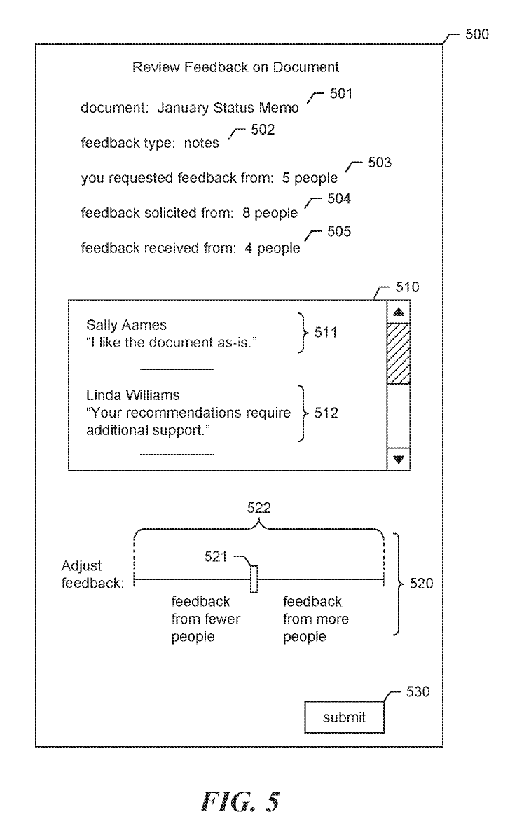

FIG. 5 is a display diagram showing a sample display presented by the facility in some embodiments to present to the author information about feedback received on the document. The display 500 includes the name 501 of the document; an indication 502 of the type of feedback requested; an indication 503 of the number of people from whom the author requested feedback; an indication 504 of the number of people from whom the facility solicited feedback; and an indication 505 of the number of people from which the facility received feedback. The display also includes a list 510 of the feedback received, including feedback 511 received from a first person, Sally Aames, and feedback 512 received from a second person, Linda Williams. The author can scroll this list to display the remaining feedback that is out of view. The display further includes a control 520 that the user may operate or manipulate to adjust the amount of feedback available in list 510. In particular, within a slider range 521, the user can drag the slider handle 521 to the left to reduce the amount of feedback, or drag it to the right to increase the amount of feedback. In some embodiments, the distance the author drags the slider handle determines the extent to which the facility seeks to reduce or increase feedback. After manipulating the slider control, the author can operate a submit control 530 in order to adjust the amount of feedback in accordance with the position of the slider handle in the slider range. In various embodiments, the facility presents controls of various types that the user can use to adjust the amount of feedback, including a rotatable knob or dial.

Returning to FIG. 2, in act 206, if the author manipulates the feedback adjustment control to request more feedback, then the facility continues in act 206; if the author manipulates the feedback adjustment control to request less feedback, then the facility continues in act 207. In act 206, the facility seeks to increase the amount of feedback, such as by sending solicitations to additional people. In various embodiments, the facility also or instead sends solicitations having different content, sends solicitations by different communication modes, etc. After act 206, the facility continues in act 203 to receive feedback in accordance with the additional solicitations it has sent. In act 207, where the author has manipulated the feedback adjustment control to request less feedback, the facility filters the feedback received in act 203 to remove feedback from one or more people. In various embodiments, the facility removes feedback based upon the extent to which the people who provided it satisfy qualifications specified by the author; the distance of each person from the author in a social graph or organization graph; the apparent value of the feedback based upon natural language processing and natural language understanding techniques; etc. After act 207, the facility continues in act 204 to present to the author information about the feedback reduced in act 207.

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

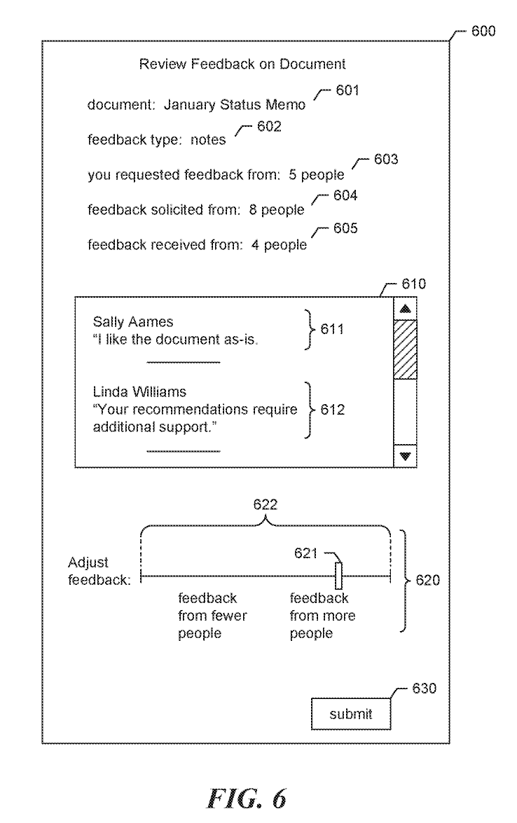

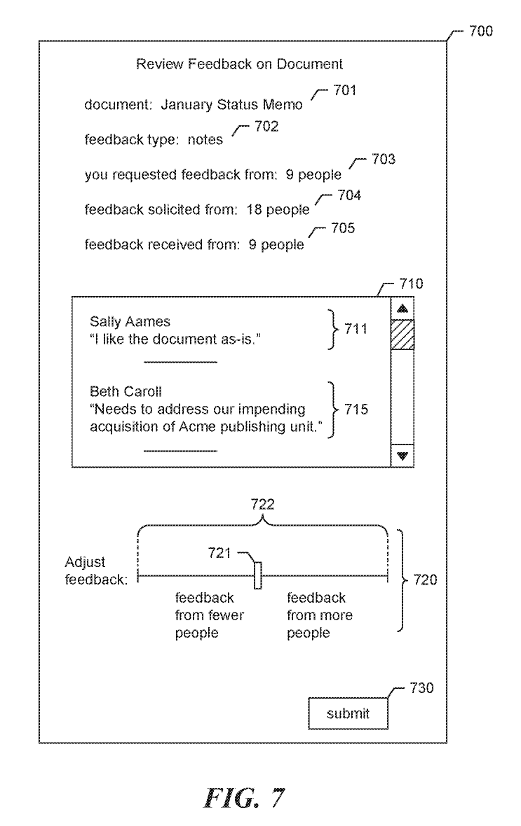

FIGS. 6 and 7 show the effect of an author's request to increase the amount of feedback for a document. FIG. 6 is a display diagram showing a sample display presented by the facility in some embodiments in which the user has dragged the slider control's slider handle to the right in order to request more feedback. It can be seen by comparing slider handle 621 shown in FIG. 6 to slider handle 521 shown in FIG. 5 that the handle has been dragged to the right, roughly halfway from the center of the slider range where it began to the right end of the slider range. After doing so, the author activates the submit control 630 to submit a request to increase the amount of feedback.

FIG. 7 is a display diagram showing a sample display presented by the facility in some embodiments that reflects the facility's collection of additional feedback in response to the author's request. It can be seen by comparing indications 703-705 in FIG. 7 to indication 603-605 in FIG. 6 that: the facility interpreted the author's dragging of the slider handle to the right as requesting feedback from nine people, in contrast with the five people from whom feedback was originally requested; the facility solicited feedback from ten additional people, on top of the eight original people; and five additional people have provided feedback, raising the total number of people who have provided feedback to nine. It can further be seen by comparing feedback list 710 shown in FIG. 7 to feedback list 610 shown in FIG. 6 that additional instances of feedback have been added to the list, such as feedback 715 from Beth Caroll. At this point, the author can again manipulate the slider handle 721 in order to further adjust the amount of feedback.

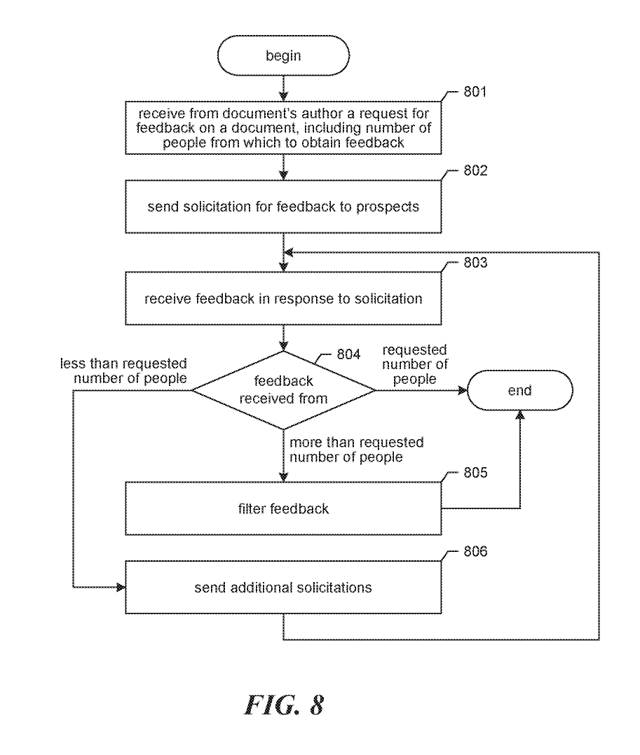

FIG. 8 is a flow diagram showing a process performed by the facility in some embodiments to solicit feedback on a document and adjust it in an automatic manner. In act 801, the facility receives from the author of the document a request for feedback on the document, including a number of people from whom to obtain feedback. In act 802, the facility sends a solicitation for feedback to prospective reviewers. In act 803, the facility receives feedback in response to the solicitation sent in act 802. In act 804, the facility branches on the number of people from whom feedback is received in act 803. If feedback is received from more than the requested number of people, then the facility continues in act 805; if feedback is received from less than the requested number of people, then the facility continues in act 806; and if feedback is received from the requested number of people, then these steps conclude and the feedback is presented to the author. In act 805, where feedback is received from more than the requested number of people. The facility filters the feedback by removing the feedback provided by different users until feedback from the requested number of people remains, then these steps conclude and the facility presents the remaining feedback to the author. In act 806, where feedback is received from less than the requested number of people, the facility sends additional solicitations, such as solicitations to additional prospective reviewers, solicitations having different content, and/or solicitations sent by different mode of communication. After act 806, the facility continues in act 803 to received feedback in response to the solicitations sent in act 806.

In some embodiments, the facility provides a method in a computing system for procuring feedback on a document on behalf of an author of the document, comprising: for each of one or more categories of document reviewers, (1) receiving first input originated by the author usable to identify prospective reviewers for the category, (2) obtaining feedback on the document from each of a first group of the prospective reviewers identified for the category, and (3) causing a representation of the obtained feedback to be presented to the author; for each of at least one of the categories of document reviewers, (1) receiving second input originated by the author indicating that additional feedback is needed from the category of document reviewers, and (2) in response to receiving the second input, obtaining feedback on the document from each of a second group of prospective reviewers identified for the category that is distinct from the first group.

In some embodiments, the facility provides one or more instances of computer-readable media collectively having contents configured to cause a computing system to perform a method for procuring feedback on a document on behalf of an author of the document, the method comprising: for each of one or more categories of document reviewers, (1) receiving first input originated by the author usable to identify prospective reviewers for the category, (2) obtaining feedback on the document from each of a first group of the prospective reviewers identified for the category, and (3) causing a representation of the obtained feedback to be presented to the author; for each of at least one of the categories of document reviewers, (1) receiving second input originated by the author indicating that additional feedback is needed from the category of document reviewers, and (2) in response to receiving the second input, obtaining feedback on the document from each of a second group of prospective reviewers identified for the category that is distinct from the first group.

In some embodiments, the facility provides a computing system comprising: a processor; and a memory, the memory having contents configured to, when executed by the processor, cause the computing system to perform a method for procuring feedback on a document on behalf of an author of the document, the method comprising: for each of one or more categories of document reviewers, (1) receiving first input originated by the author usable to identify prospective reviewers for the category, (2) obtaining feedback on the document from each of a first group of the prospective reviewers identified for the category, and (3) causing a representation of the obtained feedback to be presented to the author; for each of at least one of the categories of document reviewers, (1) receiving second input originated by the author indicating that additional feedback is needed from the category of document reviewers, and (2) in response to receiving the second input, obtaining feedback on the document from each of a second group of prospective reviewers identified for the category that is distinct from the first group.

In some embodiments, the facility provides a method in a computing system for procuring feedback on a document on behalf of an author of the document, comprising: receiving first input originated by the author usable to identify prospective reviewers; obtaining feedback on the document from each of a first group of the identified prospective reviewers; causing a representation of the obtained feedback to be presented to the author; receiving second input originated by the author indicating that additional feedback is needed; and, in response to receiving the second input, obtaining feedback on the document from each of a second group of identified prospective reviewers that is distinct from the first group.

In some embodiments, the facility provides one or more instances of computer-readable media collectively having contents configured to cause a computing system to perform a method for procuring feedback on a document on behalf of an author of the document, the method comprising: receiving first input originated by the author usable to identify prospective reviewers; obtaining feedback on the document from each of a first group of the identified prospective reviewers; causing a representation of the obtained feedback to be presented to the author; receiving second input originated by the author indicating that additional feedback is needed; and, in response to receiving the second input, obtaining feedback on the document from each of a second group of identified prospective reviewers that is distinct from the first group.

In some embodiments, the facility provides a computing system comprising: a processor; and a memory, the memory having contents configured to, when executed by the processor, cause the computing system to perform a method for procuring feedback on a document on behalf of an author of the document, the method comprising: receiving first input originated by the author usable to identify prospective reviewers; obtaining feedback on the document from each of a first group of the identified prospective reviewers; causing a representation of the obtained feedback to be presented to the author; receiving second input originated by the author indicating that additional feedback is needed; and, in response to receiving the second input, obtaining feedback on the document from each of a second group of identified prospective reviewers that is distinct from the first group.

In some embodiments, the facility provides one or more instances of computer-readable media collectively having contents configured to cause a computing system to perform a method for procuring feedback on a document on behalf of an author of the document, the method comprising: receiving first input originated by the author specifying reviewer criteria and second input originated by the author specifying a requested number of reviewers; using the reviewer criteria specified by the first input to identify a plurality of prospective reviewers; seeking feedback on the document from each of a first group of the identified prospective reviewers at least as large as the requested number of reviewers specified by the second input; receiving feedback from one or more of the identified prospective reviewers of the first group from whom feedback was sought; comparing the number of identified prospective reviewers of the first group from whom feedback was received to the requested number of reviewers specified by the second input; and based upon the results of the comparing, adapting the received feedback to be more consistent with the requested number of reviewers specified by the second input.

In some embodiments, the facility provides a method in a computing system for procuring feedback on a document on behalf of an author of the document, the method comprising: receiving first input originated by the author specifying reviewer criteria and second input originated by the author specifying a requested number of reviewers; using the reviewer criteria specified by the first input to identify a plurality of prospective reviewers; seeking feedback on the document from each of a first group of the identified prospective reviewers at least as large as the requested number of reviewers specified by the second input; receiving feedback from one or more of the identified prospective reviewers of the first group from whom feedback was sought; comparing the number of identified prospective reviewers of the first group from whom feedback was received to the requested number of reviewers specified by the second input; and based upon the results of the comparing, adapting the received feedback to be more consistent with the requested number of reviewers specified by the second input.

In some embodiments, the facility provides a computing system comprising: a processor; and a memory, the memory having contents configured to, when executed by the processor, cause the computing system to perform a method for procuring feedback on a document on behalf of an author of the document, the method comprising: receiving first input originated by the author specifying reviewer criteria and second input originated by the author specifying a requested number of reviewers; using the reviewer criteria specified by the first input to identify a plurality of prospective reviewers; seeking feedback on the document from each of a first group of the identified prospective reviewers at least as large as the requested number of reviewers specified by the second input; receiving feedback from one or more of the identified prospective reviewers of the first group from whom feedback was sought; comparing the number of identified prospective reviewers of the first group from whom feedback was received to the requested number of reviewers specified by the second input; and based upon the results of the comparing, adapting the received feedback to be more consistent with the requested number of reviewers specified by the second input.

In some embodiments, the facility provides one or more instances of computer-readable media collectively storing a feedback data structure for a distinguished document, the feedback structure comprising: for each of a plurality of contributors, feedback received from the contributor on the distinguished document, wherein the number of contributors from home the feedback data structure was adjusted in response to input from an author of the distinguished document requesting, with respect to feedback contained by the data structure at an earlier time, feedback from a larger or smaller number of contributors, such that the feedback contained by the data structure is accessible to the author of the distinguished document.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

1. A method in a computing system for procuring feedback on a document on behalf of an author of the document, comprising:
for each of one or more categories of document reviewers,
receiving first input originated by the author usable to identify prospective reviewers for the category;
obtaining feedback on the document from each of a first group of the prospective reviewers identified for the category;
causing a representation of the obtained feedback to be presented to the author;
for each of at least one of the categories of document reviewers,
receiving second input originated by the author indicating that additional feedback is needed from the category of document reviewers; and
in response to receiving the second input, obtaining feedback on the document from each of a second group of prospective reviewers identified for the category that is distinct from the first group.

2. The method of claim 1, further comprising, for a selected one of the categories of document reviewers, receiving third input originated by the author specifying at least one qualification to be satisfied by reviewers from whom feedback on the document is obtained, and wherein obtaining feedback on the document from both (1) each of the first group of the prospective reviewers identified for the selected category and (2) each of the second group of the prospective reviewers identified for the category comprises obtaining feedback from prospective reviewers who satisfy the qualifications specified by the third input.

3. The method of claim 1, further comprising, for a selected one of the categories of document reviewers, receiving third input originated by the author specifying a type of feedback on the document that is to be obtained, and wherein obtaining feedback on the document from both (1) each of the first group of the prospective reviewers identified for the selected category and (2) each of the second group of the prospective reviewers identified for the category comprises obtaining feedback of the type specified by the third input.

4. The method of claim 1 wherein, for a selected one of the categories of document reviewers:
obtaining feedback on the document from each of the first group of the prospective reviewers identified for the selected category comprises soliciting feedback from each of a third group of the prospective reviewers including all of the members of the first group, and
obtaining feedback on the document from each of the second group of the prospective reviewers identified for the selected category comprises soliciting feedback from each of a fourth group of the prospective reviewers including all of the members of the second group, the fourth group having members not in the third group.

5. The method of claim 1 wherein obtaining feedback on the document for each of the first group of the prospective reviewers identified for a selected category comprises directing a first message to a third group of the prospective reviewers identified for the selected category comprising at least the members of the first and second groups, and wherein obtaining feedback and document from each of the second group of the prospective reviewers identified for a selected category comprising directing a second message distinct from the first message to a fourth group of the prospective reviewers identified for the selected category comprising at least the members of the second group.

6. The method of claim 1 wherein obtaining feedback on the document for each of the first group of the prospective reviewers identified for a selected category comprises directing a first message to a third group of the prospective reviewers identified for the selected category comprising at least the members of the first and second groups via a first mode of communication, and wherein obtaining feedback and document from each of the second group of the prospective reviewers identified for a selected category comprising directing a second message to a fourth group of the prospective reviewers identified for the selected category comprising at least the members of the second group via a second mode of communication distinct from the first mode of communication.

7. The method of claim 6 wherein the second mode of communication is, for each of the members of the fourth group of the prospective reviewers of the selected category, adding a task to a task list maintained for the member.

8. The method of claim 6 wherein the second mode of communication is, for each of the members of the fourth group of the prospective reviewers of the selected category, adding an appointment to a schedule maintained for the member.

9. The method of claim 1, further comprising:
after obtaining feedback on the document from each of a second group of prospective reviewers identified for the category, for each of at least one of the categories of document reviewers,
receiving third input originated by the author indicating that less feedback is needed from the category of document reviewers; and
in response to receiving the third input, filtering feedback on the document obtained from the reviewers of the first and second groups to exclude the feedback obtained from one or more viewers of the first or second group.

10. One or more instances of computer-readable media collectively having contents configured to cause a computing system to perform a method for procuring feedback on a document on behalf of an author of the document, the method comprising:
receiving first input originated by the author specifying reviewer criteria and second input originated by the author specifying a requested number of reviewers;
using the reviewer criteria specified by the first input to identify a plurality of prospective reviewers;
seeking feedback on the document from each of a first group of the identified prospective reviewers at least as large as the requested number of reviewers specified by the second input;
receiving feedback from one or more of the identified prospective reviewers of the first group from whom feedback was sought;
comparing the number of identified prospective reviewers of the first group from whom feedback was received to the requested number of reviewers specified by the second input; and
based upon the results of the comparing, adapting the received feedback to be more consistent with the requested number of reviewers specified by the second input.

11. The instances of computer-readable media of claim 10, method further comprising causing a representation of the adapted received feedback to be presented to the author.

12. The instances of computer-readable media of claim 10 wherein the comparing determines that the number of identified prospective reviewers of the first group from whom feedback was received is greater than the requested number of reviewers specified by the second input, and wherein the adapting comprises:
selecting at least one of the identified prospective reviewers from feedback was received; and
discarding from the received feedback feedback received from the selected reviewers.

13. The instances of computer readable media claim 12 wherein relationships among the identified prospective reviewers are encoded in a graph that is either a social graph or an organizational graph that establishes a distance between each pair of the identified prospective reviewers, and wherein the selecting is based upon, for each identified prospective reviewer from whom feedback was received, the distance between the identified prospective reviewer and the author established by the graph.

14. The instances of computer readable media claim 12 wherein the selecting selects identified prospective reviewers from whom feedback was received that least satisfy the reviewer criteria specified by the first input.

15. The instances of computer readable media claim 12 wherein the comparing determines that the number of identified prospective reviewers from whom feedback was received is less than the requested number of reviewers specified by the second input, and wherein the adapting comprises:
seeking feedback on the document from each of a second group of the identified prospective reviewers that includes members not in the first group; and
receiving feedback from one or more of the identified prospective reviewers of the second group from whom feedback was sought.

16. The instances of computer readable media claim 12 wherein seeking feedback on the document from each of the first group of the identified prospective reviewers comprises directing a first message to each member of the first group via a first mode of communication, and wherein the comparing determines that the number of identified prospective reviewers from whom feedback was received is less than the requested number of reviewers specified by the second input, and wherein the adapting comprises directing a second message to each of a second group of the identified prospective reviewers via a second mode of communication distinct from the first mode of communication.

17. One or more instances of computer-readable media collectively storing a feedback data structure for a distinguished document, the feedback structure comprising:
for each of a plurality of contributors, feedback received from the contributor on the distinguished document,
wherein the number of contributors from whom the feedback data structure contains feedback was adjusted in response to input from an author of the distinguished document requesting, with respect to feedback contained by the data structure at an earlier time, feedback from a larger or smaller number of contributors, such that the feedback contained by the data structure is accessible to the author of the distinguished document.

18. The instances of computer-readable media of claim 17 wherein the adjustment of the number of contributors was in response to user input from the author of the distinguished document requesting feedback from a larger number of contributors.

19. The instances of computer-readable media of claim 17 wherein the adjustment of the number of contributors was in response to user input from the author of the distinguished document requesting feedback from a smaller number of contributors.
